(19) United States
(12) Patent Application Publication
(10) Pub. No.: US 2022/0007697 A1
(43) Pub. Date: Jan. 13, 2022

(54) METHOD FOR PRODUCING FOOD

(71) Applicant: J-OIL MILLS, INC., Tokyo (JP)

(72) Inventors: Junpei KUBOTA, Tokyo (JP); Chihiro ISHIKAWA, Tokyo (JP); Koji SAGARA, Tokyo (JP); Koji IWABUCHI, Tokyo (JP); Yuya NAGAHATA, Tokyo (JP); Sanshiro SAITO, Tokyo (JP)

(21) Appl. No.: 17/294,189

(22) PCT Filed: Nov. 26, 2019
(86) PCT No.: PCT/JP2019/046164

§ 371 Date: May 14, 2021

(30) Foreign Application Priority Data
Nov. 30, 2018 (JP) 2018-226092

(51) Int. Cl. A23L 13/60; A23P 20/10; A23L 13/40; A23L 29/212

(52) U.S. Cl. CPC A23L 13/62; A23P 20/105; A23L 29/212; A23P 20/11; A23L 13/43

(57) ABSTRACT

Provided is a method for producing a food including: a step of mixing a component (A) below, which is one or two selected from the group consisting of a component (A1) and a component (A2), with a food material to obtain a mixture for an outer layer; a step of mixing a food material to obtain a mixture for an inner layer; and a step of wrapping the mixture for an inner layer with the mixture for an outer layer to obtain a food composition. The component (A1) is a starch composition satisfying conditions of (1) to (3): (1) a starch content is equal to or more than 75% by mass; (2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴; and (3) a degree of swelling in cold water at 25° C. is equal to or more than 5 and equal to or less than 20, and the component (A2) is pregelatinized starch.

### TECHNICAL FIELD

The present invention relates to a method for producing a food.

### BACKGROUND ART

Patent Document 1 describes means for improving a juicy texture of a food wrapping filling.

Patent Document 1 discloses a method for producing a minced meat processed food, the method including wrapping a filling material 2 with an external ingredient 1 containing minced meat processed with transglutaminase, a production method in which a filling material 1 contains minced meat, a production method in which transglutaminase does not substantially act on minced meat contained in a filling material 1, a production method in which at least one of sodium carbonate, protease, and lipase is added to a filling material 1, and a production method in which a minced meat processed food is a hamburg steak, a minced meat cutlet, or a meatball. It is said that such a production method can provide a method for producing minced meat processed foods in which a filling material can maintain a juicy texture after cooking with heat.

### RELATED DOCUMENT

### Patent Document

[Patent Document 1] Japanese Unexamined Patent Publication No. 2017-209052

### SUMMARY OF THE INVENTION

### Technical Problem

However, the technique of Patent Document 1 does not disclose or suggest the use of a specific component containing a starch in order to improve a juicy texture of a food wrapping filing and to obtain a food having an excellent appearance at the time of eating.

### Solution to Problem

Therefore, as a result of intensive studies, the present inventors have found that when a specific component containing starch is incorporated in an outer layer of a food to be produced by wrapping, it is possible to improve a juicy texture and obtain a food having an excellent appearance at the time of eating, and completed the present invention.

That is, according to the present invention, there is provided a method for producing a food including:

a step of mixing a component (A) below with a food material to obtain a mixture for an outer layer;

a step of mixing a food material to obtain a mixture for an inner layer; and

a step of wrapping the mixture for an inner layer with the mixture for an outer layer to obtain a food composition.

Component (A): one or two selected from the group consisting of a component (A1) and a component (A2),

Component (A1): a starch composition satisfying conditions of (1) to (3) below,

(1) a starch content is equal to or more than 75% by mass,

(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴, and

(3) a degree of swelling in cold water at 25° C. is equal to or more than 5 and equal to or less than 20, and

Component (A2): pregelatinized starch.

A blending amount of the component (A) is preferably equal to or more than 0.08% by mass and equal to or less than 25% by mass in the mixture for an outer layer.

A content of the mixture for an outer layer is preferably equal to or more than 10% by mass and equal to or less than 90% by mass with respect to a total amount of the mixture for an outer layer and the mixture for an inner layer.

A content of the component (A) contained in the mixture for an outer layer is preferably equal to or more than 0.05% by mass and equal to or less than 20% by mass in the food composition.

The food is preferably a food cooked with heat.

A content of the component (A1) under a sieve having a mesh size of 0.25 mm and on a sieve having a mesh size of 0.038 mm is preferably equal to or more than 15% by mass and equal to or less than 100% by mass.

A content of the component (A1) under a sieve having a mesh size of 3.35 mm and on a sieve having a mesh size of 0.038 mm is preferably equal to or more than 60% by mass and equal to or less than 100% by mass.

The food is preferably one selected from a processed fish or livestock meat product food, a processed fish or livestock meat product-like food, and a bakery food wrapping filling.

In the step in which the mixture for an inner layer is obtained, an edible oil and fat composition is preferably added to the mixture for an inner layer such that a blending amount is equal to or more than 0.3% by mass and equal to or less than 40% by mass.

In addition, according to the present invention, there is provided a food composition obtained by wrapping a mixture for an inner layer with a mixture for an outer layer, in which the mixture for an outer layer contains a component (A) below.

Component (A): one or two selected from the group consisting of a component (A1) and a component (A2),

Component (A1): a starch composition satisfying conditions of (1) to (3) below,

(1) a starch content is equal to or more than 75% by mass,

(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴, and

(3) a degree of swelling in cold water at 25° C. is equal to or more than 5 and equal to or less than 20, and

Component (A2): pregelatinized starch.

In the food composition, a content of the component (A) is preferably equal to or more than 0.08% by mass and equal to or less than 25% by mass in the mixture for an outer layer.

In the food composition, a content of the mixture for an outer layer is preferably equal to or more than 10% by mass and equal to or less than 90% by mass with respect to a total amount of the mixture for an outer layer and the mixture for an inner layer.

In the food composition, the mixture for an inner layer preferably contains an edible oil and fat composition in an amount of equal to or more than 0.3% by mass and equal to or less than 40% by mass.

In the food composition, a content of the component (A) under a sieve having a mesh size of 0.25 mm and on a sieve having a mesh size of 0.038 mm is preferably equal to or more than 15% by mass and equal to or less than 100% by mass.

In the food composition, a content of the component (A1) under a sieve having a mesh size of 3.35 mm and on a sieve having a mesh size of 0.038 mm is preferably equal to or more than 60% by mass and equal to or less than 100% by mass.

In addition, according to the present invention, there is provided a food containing the food composition.

The food is preferably one selected from a processed fish or livestock meat product food, a processed fish or livestock meat product-like food, and a bakery food wrapping filling.

Furthermore, according to the present invention, there is provided a method for improving a juicy texture of a food containing a food composition obtained by wrapping a mixture for an inner layer with a mixture for an outer layer, the method including:

incorporating a component (A) below into the mixture for an outer layer.

Component (A): one or two selected from the group consisting of a component (A1) and a component (A2),

Component (A1): a starch composition satisfying conditions of (1) to (3) below,

(1) a starch content is equal to or more than 75% by mass,

(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴, and

(3) a degree of swelling in cold water at 25° C. is equal to or more than 5 and equal to or less than 20, and

Component (A2): pregelatinized starch.

Furthermore, according to the present invention, there is provided a method for improving an appearance, at the time of eating, of a food containing a food composition obtained by wrapping a mixture for an inner layer with a mixture for an outer layer, the method including:

incorporating a component (A) below into the mixture for an outer layer.

Component (A): one or two selected from the group consisting of a component (A1) and a component (A2),

Component (A1): a starch composition satisfying conditions of (1) to (3) below,

(1) a starch content is equal to or more than 75% by mass,

(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴, and

(3) a degree of swelling in cold water at 25° C. is equal to or more than 5 and equal to or less than 20, and

Component (A2): pregelatinized starch.

A predetermined combination of each of these configurations, or a case obtained by changing the expression of the present invention among a method, a device, and the like is also effective as an aspect of the present invention.

For example, the present invention also includes the use of one selected from a processed fish or livestock meat product food, a processed fish or livestock meat product-like food, and a bakery food wrapping filling which are obtained by the production method according to the present invention.

### Advantageous Effects of Invention

According to the production method of the present invention, it is possible to improve a juicy texture of a food wrapping filling and obtain a food also having an excellent appearance at the time of eating. The “appearance at the time of eating” here refers to a state that looks delicious with a liquid such as gravy and the like overflowing from the inside in a case where a food after cooking is broken with a knife or hand to expose an inner layer at the time of eating.

### DESCRIPTION OF EMBODIMENTS

Hereinafter, embodiments of the present invention will be described with reference to specific examples of each component. Each component can be used alone or two or more kinds thereof can be used in combination.

In the present embodiment, a method for producing a food composition includes: a step of mixing a component (A) with a food material to obtain a mixture for an outer layer; a step of mixing a food material to obtain a mixture for an inner layer; and a step of wrapping the mixture for an inner layer with the mixture for an outer layer to obtain a food composition.

In addition, in the present embodiment, the food composition includes a mixture for an inner layer wrapped with a mixture for an outer layer.

(Mixture for Outer Layer)

In the present embodiment, the mixture for an outer layer contains a food material and the following component (A).

Component (A): One or two selected from the group consisting of a component (A1) and a component (A2)

Component (A1): A starch composition satisfying conditions of (1) to (3) below

(1) A starch content is equal to or more than 75% by mass

(2) Molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴

(3) A degree of swelling in cold water at 25° C. is equal to or more than 5 and equal to or less than 20

Component (A2): Pregelatinized starch

Hereinafter, the component (A1) and the component (A2) will be described in more detail.

(Component (A1))

Specifically, the component (A1) is a starch composition containing starch as a main component.

Regarding the condition of (1), the component (A1) has a starch content of equal to or more than 75% by mass, preferably equal to or more than 80% by mass, and still more preferably equal to or more than 85% by mass, from a viewpoint of improving a juicy texture of a food.

Also, an upper limit of the starch content in the component (A1) is not limited and is equal to or less than 100% by mass, or may also be, for example, equal to or less than 99.5% by mass and equal to or less than 99% by mass, according to properties of a food.

Here, the content of the starch in the component (A1) is the content with respect to an entirety of the component (A1).

The molecular weight-reduced starch of the condition of (2) is included in the starch under the condition of (1).

Regarding the condition of (2), the peak molecular weight of the molecular weight-reduced starch is equal to or more than 3×10³, and preferably equal to or more than 8×10³, from the viewpoint of improving the juicy texture of a food. Also, from the same viewpoint, the peak molecular weight of the molecular weight-reduced starch is equal to or less than 5×10⁴, preferably equal to or less than 3×10⁴, and still more preferably equal to or less than 1.5×10⁴. A method for measuring the peak molecular weight of the molecular weight-reduced starch will be described in a section of Examples.

In addition, from a viewpoint of excellent production stability, the molecular weight-reduced starch is preferably one or more selected from the group consisting of acid-treated starch, oxidation-treated starch, or enzyme-treated starch, and more preferably the acid-treated starch.

A condition of the acid treatment is not limited, and a treatment can be performed as follows, for example.

The starch having the amylose content of equal to or more than 5% by mass and water are added to a reaction device, and then acid is further added thereto. Alternatively, acid water, in which an acid is previously dissolved in water, and the starch as a raw material are added to the reaction device. From a viewpoint of more stably performing the acid treatment, it is desirable that a total amount of the starch in the reaction is in a state of being uniformly dispersed in an aqueous phase or in a slurry state. For the purpose, a concentration of the starch slurry in the acid treatment is adjusted to be in a range, for example, equal to or more than 10% by mass and equal to or less than 50% by mass, and preferably equal to or more than 20% by mass and equal to or less than 40% by mass. When the slurry concentration is too high, slurry viscosity may increase, and it may be difficult to stir the slurry uniformly, in some cases.

Specific examples of the acid used for the acid treatment include inorganic acids such as hydrochloric acid, sulfuric acid, and nitric acid, which can be used regardless of a kind, purity, and the like.

In the acid treatment reaction, for example, a concentration of the acid during the acid treatment is preferably equal to or more than 0.05 Normality (N) and equal to or less than 4 N, more preferably equal to or more than 0.1 N and equal to or less than 4 N, and still more preferably equal to or more than 0.2 N and equal to or less than 3 N. Also, a reaction temperature is preferably equal to or higher than 30° C. and equal to or lower than 70° C., more preferably equal to or higher than 35° C. and equal to or lower than 70° C., and still more preferably equal to or higher than 35° C. and equal to or lower than 65° C. A reaction time is preferably equal to or longer than 0.5 hours and equal to or shorter than 120 hours, more preferably equal to or longer than 1 hour and equal to or shorter than 72 hours, and still more preferably equal to or longer than 1 hour and equal to or shorter than 48 hours.

A content of the molecular weight-reduced starch in the component (A1) is equal to or more than 3% by mass, preferably equal to or more than 8% by mass, and still more preferably equal to or more than 13% by mass, from the viewpoint of improving the juicy texture of a food.

On the other hand, the content of the molecular weight-reduced starch in the component (A1) is equal to or less than 45% by mass, preferably equal to or less than 35% by mass, and still more preferably equal to or less than 25% by mass, from the same viewpoint.

Here, the content of the molecular weight-reduced starch in the component (A1) is the content with respect to an entirety of the component (A1).

In addition, the amylose content in the raw material starch of the molecular weight-reduced starch is, from the viewpoint of improving the juicy texture of a food, equal to or more than 5% by mass, preferably equal to or more than 12% by mass, more preferably equal to or more than 22% by mass, still more preferably equal to or more than 45% by mass, still further preferably equal to or more than 55% by mass, and most preferably equal to or more than 60% by mass. An upper limit of the amylose content in the raw material starch of the molecular weight-reduced starch is not limited, and is equal to or less than 100% by mass, preferably equal to or less than 90% by mass, and more preferably equal to or less than 80% by mass.

As the starch which is the raw material of the molecular weight-reduced starch and has the amylose content of equal to or more than 5% by mass, one or more selected from the group consisting of high amylose corn starch, corn starch, tapioca starch, sweet potato starch, potato starch, wheat starch, high amylose wheat starch, rice starch, and processed starch obtained by processing these raw materials chemically, physically, or enzymatically can be used. From the viewpoint of improving the juicy texture of a food, it is preferable to use one or more selected from high amylose corn starch, corn starch, and tapioca starch. Also, from the same viewpoint, the starch having the amylose content of equal to or more than 5% by mass is preferably the high amylose corn starch. The high amylose corn starch having the amylose content of equal to or more than 40% by mass is available. The starch having the amylose content of equal to or more than 5% by mass is more preferably corn starch having the amylose content of equal to or more than 40% by mass.

Also, the component (A1) satisfies a specific condition of (3) regarding the degree of swelling in cold water.

Regarding the condition of (3), from the viewpoint of improving the juicy texture of a food, the degree of swelling in cold water at 25° C. of the component (A1) is equal to or more than 5, preferably equal to or more than 5.5, still more preferably equal to or more than 6, and still further preferably equal to or more than 6.5.

In addition, from the same viewpoint, the degree of swelling in cold water at 25° C. of the component (A1) is equal to or less than 20, preferably equal to or less than 17, and still more preferably equal to or less than 15.

Here, a method for measuring the degree of swelling in cold water will be described in a section of Examples.

Next, a particle size for the component (A1) will be described.

The content of the component (A1) under a sieve having a mesh size of 3.35 mm and on a 0.038 mm sieve is preferably equal to or more than 60% by mass, more preferably equal to or more than 80% by mass, still more preferably equal to or more than 85% by mass, and still further preferably equal to or more than 90% by mass, and even more preferably equal to or more than 95% by mass with respect to the entirety of the component (A1), from the viewpoint of improving the juicy texture of a food.

In addition, an upper limit of the content under the sieve having a mesh size of 3.35 mm and on the 0.038 mm sieve is equal to or less than 100% by mass.

In addition, the content of the component (A1) under a sieve having a mesh size of 0.25 mm and on a sieve having a mesh size of 0.038 mm is preferably equal to or more than 15% by mass, more preferably equal to or more than 20% by mass, and still more preferably equal to or more than 22% by mass, from the viewpoint of increasing the amount of liquid when cut.

An upper limit of the content of the component (A1) under a sieve having a mesh size of 0.25 mm and on a sieve having a mesh size of 0.038 mm is not limited, is equal to or less than 100% by mass, and from viewpoints of improving the juicy texture and ease of loosening, is preferably equal to or less than 97% by mass, more preferably equal to or less than 70% by mass, and still more preferably equal to or less than 60% by mass.

In addition, in the component (A1), the content under a sieve having a mesh size of 0.5 mm and on a sieve having a mesh size of 0.075 mm is preferably equal to or more than 30% by mass, more preferably equal to or more than 35% by mass, and still more preferably equal to or more than 40% by mass, from the viewpoint of increasing the amount of liquid when cut.

An upper limit of the content under a sieve having a mesh size of 0.5 mm and on a sieve having a mesh size of 0.075 mm is not limited, is equal to or less than 100% by mass, and from viewpoints of improving the juicy texture and ease of loosening, is preferably equal to or less than 95% by mass, more preferably equal to or less than 90% by mass, and still more preferably equal to or less than 87% by mass.

The sieve used in the present embodiment is in accordance with JIS-Z8801-1 standard.

The content of the component (A1) on or under a predetermined sieve is a content of a fraction on or under the sieve with respect to the entirety of the component (A1) when the component (A1) has passed through the predetermined sieve.

In the present embodiment, various starches can be used as a starch component other than the molecular weight-reduced starch in the component (A1). Specifically, starch generally available on the market can be selected depending on use. For example, in a case of starch for foods, regardless of a kind, one or more kinds of starch such as corn starch, wheat starch, potato starch, tapioca starch, and processed starch obtained by processing these starches chemically, physically, or enzymatically; and the like can be appropriately selected. Preferably, one or more starch selected from the group consisting of the corn starch, the wheat starch, the potato starch, the tapioca starch, and cross-linked starch thereof may be contained, and more preferably the corn starch may be contained.

In addition, a component other than the starch can be blended with the component (A1) in the present embodiment.

Specific examples of the component other than the starch include a pigment or an insoluble salt such as calcium carbonate, and calcium sulfate. It is preferable to blend the insoluble salt, and it is more preferable that a blending amount of the insoluble salt is equal to or more than 0.1% by mass and equal to or less than 2% by mass.

Next, a method for producing the component (A1) will be described. The method for producing the component (A1) includes, for example, the following steps.

(Step of preparing molecular weight-reduced starch) A step of reducing the molecular weight of the starch having the amylose content of equal to or more than 5% by mass to obtain the molecular weight-reduced starch having a peak molecular weight of equal to or more than 3×10³ and equal to or less than 5×10⁴.

(Granulation step) A step of granulating, by heat gelatinization, the raw material in which equal to or more than 3% by mass and equal to or less than 45% by mass of the molecular weight-reduced starch is contained, and the total amount of molecular weight-reduced starch and starch other than the molecular weight-reduced starch is equal to or more than 75% by mass.

The step of preparing the molecular weight-reduced starch is a step of decomposing the starch having the amylose content of equal to or more than 5% by mass into the molecular weight-reduced starch. The decomposition referred to here refers to decomposition accompanied by molecular weight reduction of starch, and examples of a typical decomposition method include decomposition by an acid treatment or an oxidation treatment, and an enzyme treatment. Among the treatments, acid treatment is preferable from the viewpoints of a decomposition rate or costs, and reproducibility of a decomposition reaction.

Further, in the granulation step, a general method used for granulating starch can be used, and it is preferable to use a general method used for heat gelatinization of starch, in terms of achieving a predetermined degree of swelling in cold water. Specifically, a method using a machine such as a drum dryer, a jet cooker, an extruder, or a spray dryer is known. However, in the present embodiment, from the viewpoint of more reliably obtaining the component (A1) in which the degree of swelling in cold water satisfies the above-mentioned specific condition, the heat gelatinization with the extruder or the drum dryer is preferable, and the extruder is more preferable.

In a case of an extruder treatment, usually, water is added to a raw material containing starch to adjust the moisture content to about 10% to 60% by mass, and then heated and swelled, for example, in conditions of a barrel temperature of 30° C. to 200° C., an outlet temperature of 80° C. to 180° C., a screw rotation speed of 100 to 1,000 rpm, and a heat treatment time of to 60 seconds.

In the present embodiment, for example, the component (A1) satisfying the condition of (3) may be obtained by the step of heat-gelatinizing the specific raw material and by, as needed, pulverizing and sieving a granulated product obtained by heat gelatinization and appropriately adjusting a size thereof.

(Component (A2))

The component (A2) in the present embodiment is pregelatinized starch other than the component (A1). Specifically, the component (A2) is obtained by gelatinizing starch.

As a raw material of the pregelatinized starch, one or more selected from the group consisting of high amylose corn starch, corn starch, tapioca starch, sweet potato starch, potato starch, wheat starch, high amylose wheat starch, rice starch, and processed starch obtained by processing these raw materials chemically, physically, or enzymatically can be used. From the viewpoint of improving the juicy texture of a food, it is preferable to use one or more selected from high amylose corn starch, corn starch, and tapioca starch, and the high amylose corn starch is more preferable. Here, the high amylose corn starch is a corn starch whose amylose content has been increased by breeding. The high amylose corn starch having the amylose content of equal to or more than 40% by mass is available. The amylose content of the high amylose corn starch is preferably equal to or more than 40%, more preferably equal to or more than 45% by mass, and still more preferably equal to or more than 48% by mass.

In addition, and upper limit of the amylose content of the high amylose corn starch is not limited, is equal to or less than 100% by mass, and from the viewpoint of improving the juicy texture of a food, is preferably equal to or less than 75% by mass, more preferably equal to or less than 70% by mass, still more preferably equal to or less than 65% by mass, still further preferably equal to or less than 60% by mass, and particularly preferably equal to or less than 55% by mass.

Here, examples of the pregelatinization treatment method include a jet cooker treatment, a drum dryer treatment, and an extruder treatment.

In addition, as an index showing the degree of pregelatinization of pregelatinized starch, the above-mentioned degree of swelling in cold water can be used.

From the viewpoint of improving the juicy texture of a food, the degree of swelling in cold water at 25° C. of the pregelatinized starch is preferably equal to or more than 3, more preferably equal to or more than 4, still more preferably equal to or more than 4.5, still further preferably equal to or more than 5, and even more preferably equal to or more than 5.5, in terms of dry matter.

From the same viewpoint, the degree of swelling in cold water at 25° C. of the pregelatinized starch is preferably equal to or less than 40, more preferably equal to or less than 30, still more preferably equal to or less than 20, still further preferably equal to or less than 15, and even more preferably equal to or less than 12, in terms of dry matter.

A food material is mixed with one or two kinds of the components (A) selected from the component (A1) and the component (A2) obtained as described above to obtain a mixture for an outer layer. The method of mixing the component (A) with the food material is not limited, and mixing may be carried out by hand or various mixers or the like may be used.

(Food Material)

A food material in the present embodiment is not limited as long as it is a food material normally used for a food. Specific examples thereof include grains or cereal flour such as rice, wheat, barley, corn, and soybeans and a processed product thereof; vegetables; fruit; livestock meat, and the processed meat thereof into minced meat or paste, fish meat and fish paste; sugars such as sugar, fructose, glucose, isomerized glucose syrup, invert sugar, oligosaccharides, dextrin, trehalose, and sugar alcohol; sweeteners such as aspartame, acesulfame potassium; starch or a starch composition other than the component (A) described above; dietary fiber such as bran, cellulose, and indigestible dextrin; leavening agents such as baking powder; edible oil and fat such as margarine, shortening, rapeseed oil, and soybean oil; milk products such as milk, skim milk powder, full-fat milk powder, cheese, and yogurt; eggs such as whole eggs and whole egg powder; thickening polysaccharides such as guar gum and alginate; emulsifier; flavoring material such as cocoa powder and matcha powder; and seasonings such as salt, sake, soup stock, and monosodium glutamate.

The food materials used in the mixture for an outer layer and the mixture for an inner layer may be the same as or different from each other.

The blending amount of the component (A) in the mixture for an outer layer is preferably equal to or more than 0.08% by mass, more preferably equal to or more than 0.2% by mass, and still more preferably equal to or more than 0.4% by mass, from the viewpoint of improving the juicy texture of a food and increasing the amount of liquid flowing out of the food. From the viewpoint of suppressing roughness and improving the fibrous texture, the blending amount of the component (A) in the mixture for an outer layer is preferably equal to or less than 25% by mass, more preferably equal to or less than 18% by mass, still more preferably equal to or less than 10% by mass, and still further preferably equal to or less than 6% by mass.

Here, the blending amount of the component (A) in the mixture for an outer layer is the amount of the component (A) blended in the outer layer with respect to the entire mixture for an outer layer.

(Mixture for Inner Layer)

As the mixture for an inner layer in the present embodiment, the food material may be used as it is, and it is preferable to use a mixture obtained by mixing a plurality of food materials. As the food material, those exemplified in the section of Mixture for outer layer can be preferably used. The food material used in the mixture for an inner layer preferably includes a fish meat or livestock meat material, a processed fish meat or livestock meat material, and a processed fish meat or livestock meat-like material.

The mixture for an inner layer may have the same composition as the mixture for an outer layer or may have a different composition therefrom, but preferably does not contain the component (A) from the viewpoint of improving the juicy texture of a food.

The mixture for an inner layer in the present embodiment preferably contains the edible oil and fat composition in the amount of equal to or more than 0.3% by mass, and from the viewpoint of increasing the amount of liquid flowing out from a food, the edible oil and fat composition is contained in the amount of preferably equal to or more than 1% by mass, more preferably equal to or more than 2% by mass, still more preferably equal to or more than 4% by mass, even more preferably equal to or more than 6% by mass, and even further preferably equal to or more than 10% by mass. In addition, from the viewpoint of improving the ease of loosening of a food, the mixture for an inner layer preferably contains the edible oil and fat composition in the amount of equal to or less than 40% by mass, more preferably equal to or less than 36% by mass, and still more preferably equal to or less than 32% by mass.

The content of the edible oil and fat composition in the mixture for an inner layer is a content with respect to the entirety of the mixture for an inner layer.

In the food composition of the present embodiment, a mass ratio of the component (A) in the mixture for an outer layer to the edible oil and fat composition added to the mixture for an inner layer is preferably equal to or more than 0.03, more preferably equal to or more than 0.05, and still more preferably equal to or more than 0.07, from the viewpoint of improving the juicy texture and the ease of loosening. In addition, the mass ratio of the component (A) in the mixture for an outer layer to the edible oil and fat composition added to the mixture for an inner layer is preferably equal to or less than 3, more preferably equal to or less than 1.5, still more preferably equal to or less than 1, and even more preferably equal to or less than 0.9, from the viewpoint of suppressing roughness and improving the fibrous texture.

(Edible Oil and Fat Composition)

The edible oil and fat composition to be added to the mixture for an inner layer is a composition containing an edible oil and fat, and the edible oil and fat content is preferably equal to or more than 60% by mass and equal to or less than 100% by mass, more preferably equal to or more than 70% by mass and equal to or less than 100% by mass, and still more preferably equal to or more than 75% by mass and equal to or less than 100% by mass.

Here, the content of the edible oil and fat in the edible oil and fat composition is the content of the edible oil and fat in the entirety of the edible oil and fat composition.

The edible oil and fat composition is not limited, and a form of butter, margarine, fat spread, shortening, or the like can be used.

As the edible oil and fat, those used for normal edible use can be used. Specifically, examples thereof include vegetable oils such as a palm kernel oil, a palm oil, a coconut oil, a corn oil, a cottonseed oil, a soybean oil, a rapeseed oil, a rice oil, a sesame oil, an olive oil, a sunflower oil, a safflower oil, a flaxseed oil, a perilla seed oil, and a cacao butter; animal fats and oils such as milk fat, lard, beef tallow, and kenne fat; a medium chain fatty acid triglyceride, and the like; and processed fats and oils that have undergone one or more processing treatments such as fractionating, transesterification, and hydrogenation, and one or more kinds thereof can be used in combination.

A solid fat content (SFC) of the edible oil and fat contained in the edible oil and fat composition at 20° C. is preferably equal to or less than 55%, more preferably equal to or less than 50%, and still more preferably equal to or less than 45% by mass, from the viewpoint of improving the juicy texture of a food. In addition, from the same viewpoint, a lower limit of the solid fat content of the edible oil and fat composition at 20° C. may be, for example, equal to or more than 0%, preferably equal to or more than 5%, and more preferably equal to or more than 15%.

A solid fat content (SFC) of the edible oil and fat contained in the edible oil and fat composition at 10° C. is preferably equal to or less than 95%, more preferably equal to or less than 85%, and still more preferably equal to or less than 75% by mass, from the viewpoint of improving the juicy texture of a food. In addition, from the same viewpoint, a lower limit of the solid fat content of the edible oil and fat composition at 10° C. may be, for example, equal to or more than 0%, preferably equal to or more than 5%, more preferably equal to or more than 15%, and still more preferably equal to or more than 25%.

A solid fat content (SFC) of the edible oil and fat contained in the edible oil and fat composition at 35° C. is preferably equal to or less than 10%, more preferably equal to or less than 9%, and still more preferably equal to or less than 8% by mass, from the viewpoint of improving the juicy texture of a food. In addition, from the same viewpoint, a lower limit of the solid fat content of the edible oil and fat composition at 35° C. may be, for example, equal to or more than 0%.

(Food Composition)

The food composition according to the present embodiment is formed by wrapping the mixture for an inner layer with the mixture for an outer layer of the present embodiment to form an inner layer and an outer layer. Here, there may be one inner layer or a plurality of inner layers. There may be one outer layer or a plurality of outer layers. Also, an outer layer other than the mixture for an outer layer of the present embodiment may be contained. In addition, bakery doughs for meat buns, savoury breads, and piroshki skins are also one aspect of the mixture for an outer layer of the present embodiment. However, batter of a fried food or tempura is not included in the outer layer of the present embodiment.

In a case where the food composition of the present embodiment has a plurality of outer layers, the mixture for an outer layer of the present embodiment is preferably the outermost layer. In a case where the food composition has a plurality of outer layers, the component (A) is preferably blended in the food composition of the outermost layer.

(Wrapping Method)

In the production method of the present embodiment, the method for wrapping the mixture for an inner layer with the mixture for an outer layer in order to obtain the food composition is not limited as long as the mixture for an inner layer is covered with the mixture for an outer layer, and the method may be performed by a known method as appropriate.

Wrapping can be performed manually, but industrially, for example, commercially available fully automatic wrapping machines can be used, and it is preferable to use a fully automatic wrapping machine.

Further, it is preferable to cover substantially the entire surface of the mixture for an inner layer with the mixture for an outer layer. Here, “cover substantially the entire surface of the mixture for an inner layer” means covering the entire surface of the mixture for an inner layer except for a fine uncovered portion such as a pinhole that is inevitably formed.

From the viewpoint of improving the juicy texture of a food, a content of the mixture for an outer layer in the food composition is preferably equal to or more than 10% by mass and equal to or less than 90% by mass, more preferably equal to or more than 30% by mass and equal to or less than 90% by mass, still more preferably equal to or more than 50% by mass and equal to or less than 87% by mass, and still further preferably equal to or more than 55% by mass and equal to or less than 85% by mass, with respect to the total amount of the mixture for an outer layer and the mixture for an inner layer.

From the same viewpoint, the content of the mixture for an outer layer in the food composition is preferably equal to or more than 10% by mass, more preferably equal to or more than 30% by mass, and still more preferably equal to or more than 50% by mass, and still further preferably equal to or less than 55% by mass, and is preferably equal to or less than 90% by mass, more preferably equal to or less than 87% by mass, and still more preferably equal to or less than 85% by mass, with respect to the total amount of the mixture for an outer layer and the mixture for an inner layer.

The food composition obtained as above may be eaten as a food as it is or may obtain a food by cooking with heat, and it is preferable that the food composition is cooked with heat. Specific examples of the cooking with heat include baking, boiling, microwave heating, steaming, steam convection heating, frying. One or more types of cooking with heat selected from the baking, the steaming, the steam convection heating, and frying are preferable.

In a case of cooking the food composition produced by the production method of the present embodiment, the food composition may be stored frozen or refrigerated before cooking with heat and then heated. Alternatively, a food obtained after cooking with heat may be stored frozen, refrigerated, or retort-packed at a room temperature, and then reheated at the time of eating. As a method for reheating, the same method as that mentioned in the cooking with heat described above can be applied, and heating by a microwave oven is preferable.

The content of the component (A) contained in the mixture for an outer layer is preferably equal to or more than 0.05% by mass and equal to or less than 20% by mass, more preferably equal to or more than 0.1% by mass and equal to or less than 10% by mass, and still more preferably equal to or more than 0.2% by mass and equal to or less than 6% by mass, in the food composition, from the viewpoint of improving the juicy texture of a food.

From the same viewpoint, the content of the component (A) contained in the mixture for an outer layer is preferably equal to or more than 0.05% by mass, more preferably equal to or more than 0.1% by mass, and still more preferably equal to or more than 0.2% by mass, and is preferably equal to or less than 20% by mass, more preferably equal to or less than 10% by mass, and still more preferably equal to or less than 6% by mass, in the food composition.

Here, the content of the component (A) contained in the mixture for an outer layer in the food composition is the content of the component (A) contained in the mixture for an outer layer with respect to the entire food composition.

Further, the food composition may further contain a food material, in addition to the mixture for an outer layer and the mixture for an inner layer.

(Food)

The food in the present embodiment is not limited, and specific examples thereof include fish or livestock meat product foods such as hamburg steak, minced meat cutlet, meat loaf, meat balls, soup dumplings (xiaolongbao), Japanese dumplings (gyoza), and steamed pork dumplings(shumai); processed fish or livestock meat product-like foods in which livestock meat is replaced with soy protein or the like; bakery foods wrapping filling such as savoury breads, meat buns, wrapped pies, and wrapped pizzas; and steamed bun, and is preferably one selected from the group consisting of fish or livestock meat product food, processed fish or livestock meat product-like food, and bakery food wrapping filling.

Since the food containing the food composition in the present embodiment contains the component (A) as an active ingredient in the outer layer, the juicy texture can be improved.

Also, since the food containing the food composition in the present embodiment contains the component (A) as an active ingredient in the outer layer, the appearance at the time of eating can be improved.

### EXAMPLES

Examples of the present invention will be shown below, but the gist of the present invention is not limited thereto.

The following raw materials were mainly used.

(Starch)

β-starch (corn starch): Corn starch Y, manufactured by J-OIL MILLS, INC.

High amylose corn starch: HS-7, manufactured by J-OIL MILLS, INC., (amylose content: 70% by mass)

Pregelatinized high amylose corn starch: JELCALL AH-F, manufactured by J-OIL MILLS, INC., (amylose content: 50% by mass, degree of swelling in cold water of 6.5)

(Edible Oil and Fat Composition)

Edible oil and fat composition 1: beef tallow (refined beef tallow), manufactured by Ueda Oil Co., Ltd.

Edible oil and fat composition 2: AJINOMOTO Olive Oil Extra Virgin, manufactured by J-Oil Mills, INC.

Edible oil and fat composition 3: Lard, manufactured by Megmilk Snow Brand Co., Ltd.

Edible oil and fat composition 4: “AJINOMOTO Goma-yu Zuki no Goma-yu” (AJINOMOTO Sesame oil lover), manufactured by J-Oil Mills, INC.

Edible oil and fat composition 5: Produced in Production Example 2 to be described later

Edible oil and fat composition 6: “AJINOMOTO Sara-sara canola-yu” (AJINOMOTO smooth canola oil), manufactured by J-Oil Mills, INC. (all SFC at 10° C., 20° C., and 35° C. are 0%)

(Others)

Soy protein: Fuji Pro FR, manufactured by Fuji Oil Co., Ltd.

Granular soy protein: New Fujinic AR, manufactured by Fuji Oil Co., Ltd.

Strong flour: “Camellia”, manufactured by Nisshin Foods Inc.

Soft flour: “Flour”, manufactured by Nisshin Foods Inc.

Baking powder: Baking powder red, manufactured by Aikoku Co., Ltd.

Semi-dry yeast: Saf semi-dry yeast, manufactured by LESAFFRE

Evaporated milk: Hokkaido concentrated milk, manufactured by Megmilk Snow Brand Co., Ltd.

Liquid sugar: “Marvie”, manufactured by H+B Life Sciences

### (Production Example 1) Production of Component (A1)

In the present example, acid-treated starch was used as the molecular weight-reduced starch to obtain the component (A1).

(Method for Producing Acid-Treated High Amylose Corn Starch)

High amylose corn starch was suspended in water to prepare 35.6% (w/w) slurry, and was heated to 50° C. A reaction was started by adding an aqueous hydrochloric acid solution prepared to be 4.25 N in an amount of 1/9 times in terms of a mass ratio of the slurry while stirring. After reacting for 16 hours, it was neutralized with 3% NaOH, washed with water, dehydrated, and dried to obtain acid-treated high amylose corn starch.

The peak molecular weight of the obtained acid-treated high amylose corn starch was measured by a method below, as a result, the peak molecular weight was 1.2×10⁴.

(Method for Measuring Peak Molecular Weight)

The peak molecular weight was measured using an HPLC unit manufactured by Tosoh Corporation (Pump DP-8020, RI detector RS-8021, and Degassing device SD-8022).

(1) A sample was pulverized, and a fraction under a sieve having a mesh size of 0.15 mm was collected using a sieve of JIS-Z8801-1 standard. This collected fraction was suspended in a mobile phase so as to be 1 mg/mL, and the suspension was heated at 100° C. for 3 minutes to completely dissolve. Filtration was performed using a 0.45 μm filtration filter (manufactured by ADVANTEC, DISMIC-25HP PTFE 0.45 μm), and a filtrate was used as an analytical sample.

(2) A molecular weight was measured under the following analysis conditions.

Column: Two columns of TSKgel ax-M (7.8 mmcp, 30 cm) (made by Tosoh Corporation)

Flow rate: 0.5 mL/min

Mobile phase: 5 mM 90% (v/v) dimethyl sulfoxide solution containing sodium nitrate

Column temperature: 40° C.

Analytical volume: 0.2 mL

(3) The detector data was collected by software (multi-station GPC-8020 model II data collection ver. 5.70, manufactured by Tosoh Corporation), and the molecular weight peak was calculated.

For a calibration curve, Pullulan with a known molecular weight (Shodex Standard P-82, manufactured by Showa Denko KK) was used.

(Method for Producing Component (A1))

79% by mass of β-starch, 20% by mass of acid-treated high amylose corn starch obtained by the above method, and 1% by mass of calcium carbonate were mixed in a bag to be sufficiently uniform. A mixture was heat-treated under pressure using a twin-screw extruder (KEI-45 manufactured by Kowa Industry Co., Ltd.). Processing conditions are as follows.

Raw material supply: 450 g/min

Water addition: 17% by mass

Barrel temperature: 50° C., 70° C., and 100° C. from the raw material inlet to the outlet

Outlet temperature: 100° C. to 110° C.

Screw rotation speed of 250 rpm

A heat-gelatinized product obtained by the extruder treatment in this manner was dried at 110° C. to adjust the moisture content to about 10% by mass.

Next, the dried heat-gelatinized product was pulverized with a desktop cutter pulverizer and then sieved using a sieve of JIS-Z8801-1 standard. The sieved heat-gelatinized product was mixed at a blending ratio of Table 1 to prepare two kinds of components (A1) (A1-1 and A1-2) below.

In addition, when the degree of swelling in cold water at 25° C. of the component (A1) was measured by a method to be described later, A1-1 showed 7.8 and A1-2 showed 10.5.

(Method for Measuring Degree of Swelling in Cold Water)

(1) A sample was dried by heating at 125° C. using a moisture meter (model number MX-50, manufactured by Kensei Kogyo Co., Ltd.) to measure the moisture, and the mass of dry matter was calculated from a moisture value obtained.

(2) 1 g of the sample in terms of the mass of dry matter was in a state of being dispersed in 50 mL of water at 25° C., gently stirred in a constant temperature bath at 25° C. for 30 minutes, and then centrifuged at 3000 rpm for 10 minutes (Centrifuge: Hitachi desktop centrifuge CT6E type, manufactured by Hitachi Koki Co., Ltd.,; Rotor: T4SS type swing rotor; and Adapter: 50TC×2S adapter), and separated into a sediment layer and a supernatant layer.

(3) The supernatant layer was removed, the mass of the sediment layer was measured, and this mass was set as B (g).

(4) The mass when the sediment layer was dried and solidified (105° C., constant weight) was set as C (g).

(5) A value obtained by dividing B by C was set as the degree of swelling in cold water.

TABLE 1

| | Component (A1): A1-1 | Component (A1): A1-2 |
|---|---|---|
| Fraction (% by mass) | (% by mass) | (% by mass) |
| Under 3.35 mm sieve and on 1.4 | 0.2 | |
| mm sieve | | |
| Under 1.4 mm sieve and on 1 mm | 13.2 | |
| sieve | | |
| Under 1 mm sieve and on 0.5 mm | 38.5 | 18.0 |
| sieve | | |
| Under 0.5 mm sieve and on 0.25 | 19.5 | 42.0 |
| mm sieve | | |
| Under 0.25 mm sieve and on | 10.4 | 15.0 |
| 0.15 mm sieve | | |
| Under 0.15 mm sieve and on | 13.7 | 20.0 |
| 0.075 mm sieve | | |
| Under 0.075 mm sieve and on | 3.3 | 3.7 |
| 0.038 mm sieve | | |
| Under 0.038 mm sieve | 1.2 | 1.3 |
| Total fraction (% by mass) | 100.0 | 100.0 |
| Under 0.25 mm sieve and on | 27.4 | 38.7 |
| 0.038 mm sieve (% by mass) | | |
| Under 3.35 mm sieve and on | 98.8 | 98.7 |
| 0.038 mm sieve (% by mass) | | |
| Under 0.5 mm sieve and on | 43.6 | 77.0 |
| 0.075 mm sieve (% by mass) | | |
| Degree of swelling in cold | 7.8 | 10.5 |
| water | | |

Note) For example, “under 3.35 mm sieve and on 1.4 mm sieve” means “under the sieve having a mesh size of 3.35 mm and on a 1.4 mm sieve in accordance with JIS-Z8801-1 standard”.

### (Production Example 2) Production of Edible Oil and Fat Composition 5

The edible oil and fat composition 5 was produced by a method described below.

Used raw material oils and fats of the edible oil and fat are as follows.
Rapeseed oil Product name: “AJINOMOTO Sara-sara canola-yu” (AJINOMOTO smooth canola oil), manufactured by J-Oil Mills, INC.
Palm kernel oil Refined palm kernel oil, manufactured by J-OIL MILLS, INC.
Extremely hardened coconut oil Refined coconut oil that has been extremely hardened and refined
Transesterification oil and fat 1 A mixture of 75% by mass of palm stearin (iodine value 35), 10% by mass of palm oil, and 15% by mass of soybean oil, that has been transesterified using sodium methoxide as a catalyst, and further refined
Transesterification oil and fat 2 A mixture of 30% by mass of palm oil and 70% by mass of palm kernel oil that has been extremely hardened, transesterified using sodium methoxide as a catalyst, and further refined
Transesterified oil and fat 3 Product name; Parkid Y, manufactured by Fuji Oil Co., Ltd.

(Preparation of Edible Oil and Fat Composition 5)

Raw material oils and fats (5 parts of rapeseed oil, 35 parts of palm kernel oil, 15 parts of extremely hardened coconut oil, 20 parts of transesterified oil and fat 1, 5 parts of transesterified oil and fat 2, and 20 parts of transesterified oil and fat 3) were dissolved at 60° C. and rapidly cooled and kneaded using a perfector to obtain the edible oil and fat composition 5.

Also, Table 2 shows the solid fat content (SFC) of the edible oils and fats contained in the edible oil and fat compositions 1 to 5.

(Method for Measuring SFC)

The solid fat content (SFC) (%) was measured according to AOCS Official Method Cd 16b-93 METHOD I.

TABLE 2

| Kinds of edible | | | |
|---|---|---|---|
| oil and fat | SFC of edible oil and fat (%) | | |
| composition | 10° C. | 20° C. | 35° C. |
| Edible oil and fat | 41.0 | 23.7 | 5.9 |
| composition 1 | | | |
| Edible oil and fat | 0 | 0 | 0 |
| composition 2 | | | |
| Edible oil and fat | 53.4 | 27.0 | 4.1 |
| composition 3 | | | |
| Edible oil and fat | 0 | 0 | 0 |
| composition 4 | | | |
| Edible oil and fat | 68.2 | 36.7 | 4.7 |
| composition 5 | | | |

(Experiment 1)

In the present example, A1-1 was blended as the component (A) to prepare a mixture for an outer layer, and a hamburg steak in which the mixture for an inner layer was wrapped with the mixture for an outer layer was prepared and evaluated. Table 4 shows blending of the hamburg steak.

(Method for Producing Hamburg Steak)

A hamburg steak was produced by the following procedure according to the blending shown in Table 4.

1. (Mixing of raw material A in inner layer) In a bowl of a Kenmix mixer, the raw material A described in the column of Inner layer in Table 4 was put and kneaded by hand to make sticky.

2. (Mixing of raw material B in inner layer) Further, the raw material B shown in Table 4 was added and mixed.

3. (Kneading of inner layer) A mixture for an inner layer was obtained by mixing for 3 minutes with a Kenmix mixer (strength 1) equipped with a whisk.

4. (Mixing of raw material C in outer layer) In a bowl of a Kenmix mixer, the raw material C described in Table 4 was put and kneaded by hand to make sticky.

5. (Mixing of raw material D in outer layer) Further, the raw material D described in Table 2 was added and mixed.

6. (Kneading of outer layer) A mixture for an outer layer was obtained by mixing for 3 minutes with a Kenmix mixer (strength 1) equipped with a whisk.

7. (Forming) 37.5 g of the mixture for an inner layer was rolled, rolled so as to cover it with 112.5 g of the mixture for an outer layer, and then formed into an oval shape by hand to obtain a formed product of a food composition.

8. (Baking) The formed product was placed on an iron plate heated to 250° C., a front surface was baked for 1 minute and 30 seconds, and then turned over, the back surface was baked for 1 minute.

9. (Steaming) The food composition was placed in a steam convection oven (Rational Japan Co., Ltd., model: 61 model) set at 180° C. and a relative humidity of 60% to 70% for 8 minutes to obtain a hamburg steak.

(Sensory Evaluation)

The hamburg steak immediately after steaming was tasted, four specialized panelists evaluated the juicy texture of the hamburg steak, fibrous texture (whether there is an original fiber feeling of meat), ease of loosening (ease of loosening when chewed), and no roughness. Each evaluation item was scored by a consensus of four panelists, and a score of 3 or more was set as a pass. The scores of each item are shown in Table 3. Also, the evaluation results of each example are shown in Table 4.

TABLE 3

| | | Fibrous texture | | |
|---|---|---|---|---|
| | | (Whether there | | |
| | | is an original | | |
| | | fiber feeling | Ease of | |
| Grade * | Juicy texture | of meat) | loosening | No roughness |
| 5 | Very juicy | Having much of | Very easy to | Does not feel |
| | | original | loosen when | any roughness |
| | | fibrous texture | chewed | |
| | | of meat | | |
| 4 | Juicy | Having original | Easy to loosen | Almost does not |
| | | fibrous texture | when chewed | feel roughness |
| | | of meat | | |
| 3 | Slightly juicy | Having original | Slightly easy | Does not feel |
| | | fibrous texture | to loosen when | too roughness |
| | | of meat | chewed | |
| | | slightly | | |
| 2 | Slightly dry | Slightly | Hard to loosen | Feel roughness |
| | | uniform and | even when | |
| | | does not have | chewed | |
| | | much of | | |
| | | original | | |
| | | fibrous texture | | |
| | | of meat | | |
| 1 | Dry | Does not have | Very hard to | Feel very |
| | | original | loosen even | roughness |
| | | fibrous texture | when chewed | |
| | | of meat | | |

* Each evaluation item was scored by a consensus of four panelists, and a score of 3 or more was set as a pass.

(Calculation of Cooking Yield)

A cooking yield was calculated by a formula below using the mass of the hamburg steak after forming obtained in 7. above and the mass of the hamburg steak after steaming obtained in 9. above.

Cooking yield (%)=(Mass of hamburg steak after steaming/Mass of hamburg steak after forming)×100

The calculated values of each example are shown in Table 4.

(Measurement of Overflowing Liquid when Cut)

The kitchen paper whose mass was measured in advance was laid out, and the hamburg steak immediately after steaming was placed. The hamburg steak was cut in half from the center with a kitchen knife. The amount of liquid (g) that overflowed during cutting was calculated by measuring the change in the mass of the kitchen paper (N=1). The results are shown in Table 4.

TABLE 4

| Raw material | | | Control | | | | | |
|---|---|---|---|---|---|---|---|---|
| (parts by mass) | | | Example | Example 1 | Example 2 | Example 3 | Example 4 | Example 5 |
| Inner | A | Minced beef and pork | 16.00 | | 16.00 | 16.00 | 16.00 | 16.00 |
| layer | | (6:4) (fat content 20%) | | | | | | |
| | | Minced beef and pork | | 16.00 | | | | |
| | | (6:4) (fat content 40%) | | | | | | |
| | | Salt | 0.25 | 0.25 | 0.25 | 0.25 | 0.25 | 0.25 |
| | | Chopped onion (raw) | 3.00 | 3.00 | 3.00 | 3.00 | 3.00 | 3.00 |
| | B | Raw bread crumbs | 1.50 | 1.50 | 1.50 | 1.50 | 1.50 | 1.50 |
| | | Whole egg | 1.25 | 1.25 | 1.25 | 1.25 | 1.25 | 1.25 |
| | | Granulated sugar | 0.35 | 0.35 | 0.35 | 0.35 | 0.35 | 0.35 |
| | | Sodium glutamate | 0.08 | 0.08 | 0.08 | 0.08 | 0.08 | 0.08 |
| | | White pepper | 0.08 | 0.08 | 0.08 | 0.08 | 0.08 | 0.08 |
| | | Soy protein | 0.50 | 0.50 | 0.50 | 0.50 | 0.50 | 0.50 |
| | | Water for soy protein | 0.75 | 0.75 | 0.75 | 0.75 | 0.75 | 0.75 |
| | | Edible oil and fat | 5.00 | — | 5.00 | 5.00 | 5.00 | 5.00 |
| | | composition 1 | | | | | | |
| Total of mixture for inner layer | | | 28.76 | 23.76 | 28.76 | 28.76 | 28.76 | 28.76 |
| Edible oil and fat composition | | | 17.4 | 0.0 | 17.4 | 17.4 | 17.4 | 17.4 |
| added to mixture for inner layer | | | | | | | | |
| (% by mass) | | | | | | | | |
| Outer | C | Minced beet and pork | 48.00 | 48.00 | 48.00 | 48.00 | 48.00 | 48.00 |
| layer | | (6:4) (fat content 17.3%) | | | | | | |
| | | Salt | 0.75 | 0.75 | 0.75 | 0.75 | 0.75 | 0.75 |
| | | Chopped onion (raw) | 9.00 | 9.00 | 9.00 | 9.00 | 9.00 | 9.00 |
| | D | Raw bread crumbs | 4.50 | 4.50 | 4.50 | 4.50 | 4.50 | 4.50 |
| | | Whole egg | 3.75 | 3.75 | 3.75 | 3.75 | 3.75 | 3.75 |
| | | Granulated sugar | 1.05 | 1.05 | 1.05 | 1.05 | 1.05 | 1.05 |
| | | Sodium glutamate | 0.22 | 0.22 | 0.22 | 0.22 | 0.22 | 0.22 |
| | | White pepper | 0.22 | 0.22 | 0.22 | 0.22 | 0.22 | 0.22 |
| | | Soy protein | 1.50 | 1.50 | 1.50 | 1.50 | 1.50 | 1.50 |
| | | Water for soy protein | 2.25 | 2.25 | 2.25 | 2.25 | 2.25 | 2.25 |
| | | Component (A): A1-1 | — | 0.75 | 0.75 | 1.50 | 3.00 | 0.40 |

| | | | | | | |
|---|---|---|---|---|---|---|
| Total of mixture for outer layer | 71.24 | 71.99 | 71.99 | 72.74 | 74.24 | 71.64 |
| Component (A)/Mixture for outer | 0 | 1.04 | 1.04 | 2.06 | 4.04 | 0.56 |
| layer (% by mass) * | | | | | | |
| Component (A)/Food composition (% | 0 | 0.78 | 0.78 | 1.55 | 3.03 | 0.42 |
| by mass) ** | | | | | | |
| Component (A)/Edible oil and fat | 0 | — | 0.180 | 0.356 | 0.697 | 0.096 |
| composition added to mixture for | | | | | | |
| inner layer *** | | | | | | |
| Sensory evaluation | | | | | | |
| Juicy texture | 2 | 4 | 5 | 5 | 4 | 4 |
| Fibrous texture | 4 | 4 | 4 | 4 | 3 | 5 |
| Ease of loosening | 2 | 5 | 5 | 5 | 5 | 3 |
| No roughness | 4 | 4 | 4 | 4 | 3 | 5 |
| Numerical evaluation | | | | | | |
| Cooking yield (% by mass) | 83.3% | 80.7% | 84.0% | 84.0% | 83.7% | 80.7% |
| Amount of liquid when cut (g) | 0.98 | 1.12 | 1.59 | 1.80 | 2.41 | 1.90 |

Note)
* represents % by mass of component (A) with respect to entirety of mixture for outer layer.
** represents % by masss of component (A) with respect to entirety of food composition obtained by wrapping with Mixture for inner layer:Mixture for outer layer = 37.5:112.5 (Mass ratio)
*** represents mass ratio of component (A) to edible oil and fat composition added to mixture for inner layer, in food composition obtained by wrapping with Mixture for inner layer:Mixture for outer layer = 37.5:112.5 (Mass ratio)

As shown in Table 4, a hamburg steak prepared by blending A1-1 as the component (A) to prepare a mixture for an outer layer and wrapping a mixture for an inner layer with the mixture for an outer layer has an excellent juicy texture, and textures such as a fibrous texture, and ease of loosening, no roughness were also preferable. Also, the hamburg steak has a preferable appearance in which the liquid flowing out from the inside when cut.

When the content of the component (A) in the mixture for an outer layer was equal to or more than 0.56% by mass and equal to or less than 4.04% by mass, it was excellent from the viewpoint of a juicy texture, and when the content was equal to or more than 1.04% by mass and equal to or less than 2.06% by mass, the juicy texture was more excellent. From the viewpoint of ease of loosening, when the content was equal to or more than 0.56% by mass and equal to or less than 4.04% by mass, the ease of loosening was excellent, and when the content was equal to or more than 1.04% by mass and equal to or less than 4.04% by mass, the ease of loosening was more excellent. From the viewpoint of fibrous texture or suppressing roughness, when the content was equal to or more than 0.56% by mass and equal to or less than 4.04% by mass, texture was excellent, and when the content was equal to or more than 0.56% by mass and equal to or less than 2.06% by mass, the texture was more excellent. The amount of liquid when cut was large when the content was equal to or more than 0.56% by mass and equal to or less than 4.04% by mass.

When the content of the component (A) in the food composition was equal to or more than 0.42% by mass and equal to or less than 3.03% by mass, it was excellent from the viewpoint of a juicy texture, and when the content was equal to or more than 0.78% by mass and equal to or less than 1.55% by mass, the juicy texture was more excellent. From the viewpoint of ease of loosening, when the content was equal to or more than 0.42% by mass and equal to or less than 3.03% by mass, the ease of loosening was excellent, and when the content was equal to or more than 0.78% by mass and equal to or less than 3.03% by mass, the ease of loosening was more excellent. From the viewpoint of fibrous texture or suppressing roughness, when the content was equal to or more than 0.42% by mass and equal to or less than 3.03% by mass, texture was excellent, and when the content was equal to or more than 0.42% by mass and equal to or less than 1.55% by mass, the texture was more excellent. The amount of liquid when cut was large when the content was equal to or more than 0.42% by mass and equal to or less than 3.03% by mass.

When the mass ratio of the component (A) to the edible oil and fat composition added to the mixture for an inner layer was equal to or more than 0.096 and equal to or less than 0.697, it was excellent from the viewpoint of a juicy texture, and when the mass ratio was equal to or more than 0.180 and equal to or less than 0.356, the juicy texture was more excellent. From the viewpoint of ease of loosening, when the mass ratio was equal to or more than 0.096 and equal to or less than 0.697, the ease of loosening was excellent, and when the mass ratio was equal to or more than 0.180 and equal to or less than 0.697, the ease of loosening was more excellent. From the viewpoint of fibrous texture or suppressing roughness, when the mass ratio was equal to or more than 0.096 and equal to or less than 0.697, texture was excellent, and when the content was equal to or more than 0.096 and equal to or less than 0.356, the texture was more excellent. The amount of liquid when cut was large when the mass ratio was equal to or more than 0.096 and equal to or less than 0.697.

Further, as in Example 1, in a case where minced beef and pork having a high lipid content was used without adding the edible oil and fat composition to the mixture for an inner layer, it was found that when the mixture for an outer layer contains the component (A), a hamburg steak having an excellent juicy texture was obtained.

In addition, all the hamburg steaks obtained in each example had a favorable yield.

(Experiment 2)

In the present example, the hamburg steak was prepared and evaluated by the same operations as in Experiment 1 except that the blending was changed to that shown in Table 5. Further, as Comparative Example 1, a product to which corn starch was blended instead of the component (A) was also produced by the same operations. Table 5 shows a blend of the hamburg steak and evaluation results thereof.

TABLE 5

| Raw material | | | Control | | | | Comparative |
|---|---|---|---|---|---|---|---|
| (parts by mass) | | | Example | Example 2 | Example 6 | Example 7 | Example 1 |
| Inner | A | Minced beef and pork (6:4) | 16.00 | 16.00 | 16.00 | 16.00 | 16.00 |
| layer | | (fat content 20%) | | | | | |
| | | Salt | 0.25 | 0.25 | 0.25 | 0.25 | 0.25 |
| | | Chopped onion (raw) | 3.00 | 3.00 | 3.00 | 3.00 | 3.00 |
| | B | Raw bread crumbs | 1.50 | 1.50 | 1.50 | 1.50 | 1.50 |
| | | Whole egg | 1.25 | 1.25 | 1.25 | 1.25 | 1.25 |
| | | Granulated sugar | 0.35 | 0.35 | 0.35 | 0.35 | 0.35 |
| | | Sodium glutamate | 0.08 | 0.08 | 0.08 | 0.08 | 0.08 |
| | | White pepper | 0.08 | 0.08 | 0.08 | 0.08 | 0.08 |
| | | Soy protein | 0.50 | 0.50 | 0.50 | 0.50 | 0.50 |
| | | Water for soy protein | 0.75 | 0.75 | 0.75 | 0.75 | 0.75 |
| | | Edible oil and fat | 5.00 | 5.00 | 5.00 | 5.00 | 5.00 |
| | | composition 1 | | | | | |
| Total of mixture for inner layer | | | 28.76 | 28.76 | 28.76 | 28.76 | 28.76 |
| Edible oil and fat composition added to | | | 17.4 | 17.4 | 17.4 | 17.4 | 17.4 |
| mixture for inner layer (% by mass) | | | | | | | |
| Outer | C | Minced beef and pork (6:4) | 48.00 | 48.00 | 48.00 | 48.00 | 48.00 |
| layer | | (fat content 17.3%) | | | | | |
| | | Salt | 0.75 | 0.75 | 0.75 | 0.75 | 0.75 |
| | | Chopped onion (raw) | 9.00 | 9.00 | 9.00 | 9.00 | 9.00 |
| | D | Raw bread crumbs | 4.50 | 4.50 | 4.50 | 4.50 | 4.50 |
| | | Whole egg | 3.75 | 3.75 | 3.75 | 3.75 | 3.75 |
| | | Granulated sugar | 1.05 | 1.05 | 1.05 | 1.05 | 1.05 |
| | | Sodium glutamate | 0.22 | 0.22 | 0.22 | 0.22 | 0.22 |
| | | White pepper | 0.22 | 0.22 | 0.22 | 0.22 | 0.22 |
| | | Soy protein | 1.50 | 1.50 | 1.50 | 1.50 | 1.50 |
| | | Water for soy protein | 2.25 | 2.25 | 2.25 | 2.25 | 2.25 |
| | | Component (A): A1-1 | | 0.75 | | | |
| | | Component (A): A1-2 | | | 0.75 | | |
| | | Component (A): A2 | | | | 0.75 | |
| | | Corn starch | | | | | 0.75 |

| | | | | | |
|---|---|---|---|---|---|
| Total of mixture for outer layer | 71.24 | 71.99 | 71.99 | 71.99 | 71.99 |
| Component (A)/Mixture for outer layer (% | 0 | 1.04 | 1.04 | 1.04 | 0 |
| by mass) * | | | | | |
| Component (A)/Food composition (% by mass) ** | 0 | 0.78 | 0.78 | 0.78 | 0 |
| Component (A)/Edible oil and fat | 0 | 0.180 | 0.180 | 0.180 | 0 |
| composition added to mixture for inner | | | | | |
| layer *** | | | | | |
| Sensory evaluation | | | | | |
| Juicy texture | 2 | 5 | 4 | 4 | 2 |
| Fibrous texture | 4 | 4 | 4 | 4 | 2 |
| Ease of loosening | 2 | 5 | 4 | 4 | 2 |
| No roughness | 4 | 4 | 4 | 3 | 1 |
| Numerical evaluation | | | | | |
| Cooking yield (% by mass) | 83.3% | 84.0% | 81.7% | 85.0% | 84.0% |
| Amount of liquid when cut (g) | 0.98 | 1.59 | 2.80 | 1.85 | 0.60 |

Note)
* represents % by mass of component (A) with respect to entirety of mixture for outer layer.
** represents % by mass of component (A) with respect to entirety of food composition obtained by wrapping with Mixture for inner layer:Mixture for outer layer = 37.5:112.5 (Mass ratio)
*** represents mass ratio of component (A) to edible oil arid fat composition added to mixture for inner layer, in food composition obtained by wrapping with Mixture for inner layer:Mixture for outer layer = 37.5:112.5 (Mass ratio)

As shown in Table 5, all hamburg steaks prepared by blending A1-1, A1-2, or A2 as the component (A) to prepare a mixture for an outer layer and wrapping a mixture for an inner layer with the mixture for an outer layer has an excellent juicy texture, and textures such as a fibrous texture, ease of loosening, and no roughness were also preferable. Also, the hamburg steak has a preferable appearance in which the liquid flowing out from the inside when cut.

As the component (A1), from the viewpoint of the juicy texture and the ease of loosening, a case where the content under the sieve having a mesh size of 0.25 mm and on the sieve having a mesh size of 0.038 mm was 27.4% by mass (A1-1) was more excellent. From the viewpoint of increasing the amount of liquid when cut, a case where the content under the sieve having a mesh size of 0.25 mm and on the sieve having a mesh size of 0.038 mm was 38.7% by mass (A1-2) was more excellent.

Also, in a case of using A2 as the component (A), the amount of liquid when cut was larger than that of the control, and a preferable hamburg steak was obtained.

On the other hand, according to Comparative Example 1, in a case of using the corn starch instead of the component (A), the juicy texture, the fibrous texture, the ease of loosening, and the no roughness were inferior, and the amount of liquid when cut was also small.

(Experiment 3)

In the present example, the hamburg steak was prepared and evaluated by the same operations as in Experiment 1 except that the blending was changed to that shown in Table 6. Table 6 shows the blending of the hamburg steak and evaluation results thereof.

TABLE 6

| Raw material | | | Control | | | |
|---|---|---|---|---|---|---|
| (parts by mass) | | | Example | Example 2 | Example 8 | Example 9 |
| Inner | A | Minced beef and pork (6:4) | 16.00 | 16.00 | 16.00 | 16.00 |
| layer | | (fat content 20%) | | | | |
| | | Salt | 0.25 | 0.25 | 0.25 | 0.25 |
| | | Chopped onion (raw) | 3.00 | 3.00 | 3.00 | 3.00 |
| | B | Raw bread crumbs | 1.50 | 1.50 | 1.50 | 1.50 |
| | | Whole egg | 1.25 | 1.25 | 1.25 | 1.25 |
| | | Granulated sugar | 0.35 | 0.35 | 0.35 | 0.35 |
| | | Sodium glutamate | 0.08 | 0.08 | 0.08 | 0.08 |
| | | White pepper | 0.08 | 0.08 | 0.08 | 0.08 |
| | | Soy protein | 0.50 | 0.50 | 0.50 | 0.50 |
| | | Water for soy protein | 0.75 | 0.75 | 0.75 | 0.75 |
| | | Edible oil and fat | 5.00 | 5.00 | 10.00 | |
| | | composition 1 | | | | |
| | | Edible oil and fat | | | | 5.00 |
| | | composition 2 | | | | |
| Total of mixture for inner layer | | | 28.76 | 28.76 | 33.76 | 28.76 |
| Edible oil and fat composition added to | | | 17.4 | 17.4 | 29.6 | 17.4 |
| mixture for inner layer (% by mass) | | | | | | |
| Outer | C | Minced beef and pork (6:4) | 48.00 | 48.00 | 48.00 | 48.00 |
| layer | | (fat content 17.3%) | | | | |
| | | Salt | 0.75 | 0.75 | 0.75 | 0.75 |
| | | Chopped onion (raw) | 9.00 | 9.00 | 9.00 | 9.00 |
| | D | Raw bread crumbs | 4.50 | 4.50 | 4.50 | 4.50 |
| | | Whole egg | 3.75 | 3.75 | 3.75 | 3.75 |
| | | Granulated sugar | 1.05 | 1.05 | 1.05 | 1.05 |
| | | Sodium glutamate | 0.22 | 0.22 | 0.22 | 0.22 |
| | | White pepper | 0.22 | 0.22 | 0.22 | 0.22 |
| | | Soy protein | 1.50 | 1.50 | 1.50 | 1.50 |
| | | Water for soy protein | 2.25 | 2.25 | 2.25 | 2.25 |
| | | Component (A): A1-1 | — | 0.75 | 0.75 | 0.75 |

| Total of mixture for outer layer | 71.24 | 71.99 | 71.99 | 71.99 |
|---|---|---|---|---|
| Component (A)/Mixture for outer layer (% by | 0 | 1.04 | 1.04 | 1.04 |
| mass) * | | | | |
| Component (A)/Food composition (% by mass) ** | 0 | 0.78 | 0.78 | 0.78 |
| Component (A)/Edible oil and fat composition | 0 | 0.180 | 0.106 | 0.180 |
| added to mixture for inner layer *** | | | | |
| Sensory evaluation | | | | |
| Juicy texture | 2 | 5 | 5 | 4 |
| Fibrous texture | 4 | 4 | 4 | 4 |
| Ease of loosening | 2 | 5 | 4 | 4 |
| No roughness | 4 | 4 | 4 | 3 |
| Numerical evaluation | | | | |
| Cooking yield (% by mass) | 83.3% | 84.0% | 80.3% | 81.7% |
| Amount of liquid when cut (g) | 0.98 | 1.59 | 1.94 | 1.33 |

Note)
* represents % by mass of component (A) with respect to entirety of mixture for outer layer.
** represents % by mass of component (A) with respect to entirety of food composition obtained by wrapping with Mixture for inner layer:Mixture for outer layer = 37.5:112.5 (Mass ratio)
*** represents mass ratio of component (A) to edible oil and fat composition added to mixture for inner layer, in food composition obtained by wrapping with Mixture for inner layer:Mixture for outer layer = 37.5:112.5 (Mass ratio)

From Table 6, preferable hamburgs were obtained even when the amount and kinds of the edible oil and fat composition added to the mixture for an inner layer were changed.

Specifically, in a case of adding 29.6% by mass of the edible oil and fat composition to the mixture for an inner layer, the amount of liquid when cut was increased as compared with the case where 17.4% by mass of the edible oil and fat composition was added.

Further, as the kinds of the edible oil and fat composition, any of the edible oil and fat composition 1 and the edible oil and fat composition 2 was used, and a preferable hamburg steak was obtained. The edible oil and fat composition 1 having an SFC at 10° C., of the edible oil and fat as a raw material, of 41% and a SFC at 20° C. of 23.7% was more preferable in terms of the amount of liquid when cut, the juicy texture, and the no roughness, comparing to the edible oil and fat composition 2 having an SFC at 10° C. and 20° C., of the edible oil and fat as a raw material, of 0%.

(Experiment 4)

In the present example, the component (A) was blended with a meat bun skin to prepare a mixture for an outer layer, and a meat bun was prepared and evaluated by wrapping the mixture for an inner layer with the mixture for an outer layer.

(Production Example of Meat Bun)

1. A raw material A of the inner layer shown in Table 7 was kneaded, and then a raw material B was further added and mixed uniformly to obtain a mixture for an inner layer.

2. The raw materials of the outer layer shown in Table 7 were kneaded, fermented at 28° C. for 10 minutes, divided into 50 g portions and allowed to rest for 10 minutes to prepare a mixture for an outer layer (that is, dough for meat bun skin).

3. 30 g of the mixture for an inner layer obtained in 1. above was wrapped with 50 g of the mixture for an outer layer obtained in 2. above (62.5% by mass of the mixture for an outer layer with respect to a total amount of the mixture for an outer layer and the mixture for an inner layer), and secondarily fermented at 40° C. and 50% humidity for 30 to 35 minutes to obtain a food composition.

4. The food composition of 3. above was steamed and heated in a steam convection oven (Maruzen Co., Ltd., model SSC-03) at 100° C. for 15 minutes, and then allowed to cool at a room temperature to obtain a meat bun.

TABLE 7

| Raw material of | | Control |
|---|---|---|
| inner layer | | example |
| (parts by mass) | | and Example |
| A | Minced pork | 31.0 |
| | Edible oil and fat | 6.0 |
| | composition 3 | |
| B | Bamboo shoot | 15.0 |
| | Onion | 15.0 |
| | Shiitake mushroom | 3.0 |
| | Soy sauce | 3.0 |
| | White sugar | 2.0 |
| | Salt | 0.5 |
| | Ginger | 0.5 |
| | Sodium glutamate | 0.7 |
| | Edible oil and fat | 0.3 |
| | composition 4 | |
| | Bread crumbs | 2.0 |
| | Corn starch | 1.0 |
| | Granulated soy protein | 2.5 |
| | Water | 17.5 |

| | |
|---|---|
| Total of mixture for inner layer | 100.0 |
| Oil and fat added to mixture for inner | 6.3 |
| layer (% by mass) | |

| Raw material of | | |
|---|---|---|
| outer layer | Control | |
| (parts by mass) | example | Example 10 |
| Strong flour | 50 | 50 |
| Soft flour | 50 | 50 |
| Component (A): A1-2 | | 3 |
| Leavening agent | 1 | 1.1 |
| Salt | 1 | 1.1 |
| White sugar | 10 | 11 |
| Semi-dry yeast | 0.80 | 0.88 |
| Edible oil and fat composition 3 | 3 | 3.3 |
| Evaporated milk | 8 | 8.8 |
| Water | 46 | 56 |
| Total of mixture for outer layer | 169.8 | 185.18 |
| Component (A)/Mixture for outer layer (% | 0 | 1.62 |
| by mass) * | | |
| Component (A)/Food composition (% by | 0 | 1.01 |
| mass) ** | | |
| Component (A)/Edible oil and fat | 0 | 0.429 |
| composition added to mixture for inner | | |
| layer *** | | |

Note)
* represents % by mass of component (A) with respect to entirety of mixture for outer layer.
** represents % by mass of component (A) with respect to entirety of food composition obtained by wrapping with Mixture for inner layer:Mixture for outer layer = 30:50 (Mass ratio)
*** represents mass ratio of component (A) to edible oil and fat composition added to mixture for inner layer, in food composition obtained by wrapping with Mixture for inner layer:Mixture for outer layer = 30:50 (Mass ratio)

As shown in Table 7, the meat bun wrapped with the mixture for an outer layer of Example 10 had a juicy inner layer compared to the control example, which was highly preferable.

Further, even in a case where, as the edible oil and fat composition, two kinds of edible oil and fat compositions of the edible oil and fat composition 3 in which an SFC of the edible oil and fat as a raw material at 10° C. was 53.4% and an SFC at 20° C. was 27.0% and the edible oil and fat composition 4 in which an SFC of the edible oil and fat as a raw material at 10° C. and 20° C. was 0% were blended into the mixture for an outer layer and the mixture for an inner layer, respectively, a preferred food was obtained.

(Experiment 5)

The hamburg steak was formed and baked in the same blending and the same procedure as in Example 2 above, except that the edible oil and fat composition 1 was changed to the edible oil and fat composition 5. After cooling to a room temperature, the hamburg steaks were wrapped in food plastic wrap one by one, put in a zipper bag, and left in a freezer (set temperature: −20° C.). One week later, the hamburg steak taken out of the freezer was heated in a microwave oven at 1000 W for 3 minutes and eaten, and a very preferable hamburg steak was obtained in which the inner layer was juicy and the liquid flowed out when cut.

According to Experiments 3 to 5, from the viewpoint of the juicy texture, the edible oil and fat composition was excellent when the solid fat content of the raw material edible oil and fat as a raw material, at 10° C. was equal to or more than 0% and equal to or less than 68.2%, and was more excellent when the solid fat content was equal to or more than 41.0% and equal to or less than 68.2%. In addition, from the same viewpoint, the edible oil and fat composition was excellent when the solid fat content of the raw material edible oil and fat as a raw material, at 20° C. was equal to or more than 0% and equal to or less than 36.7%, and was more excellent when the solid fat content was equal to or more than 23.7% and equal to or less than 36.7%. Furthermore, from the same viewpoint, the edible oil and fat composition was excellent when the solid fat content of the raw material edible oil and fat as a raw material, at 35° C. was equal to or more than 0% and equal to or less than 5.9%, and was more excellent when the solid fat content was equal to or more than 4.1% and equal to or less than 5.9%.

Further, the hamburg steak produced by the production method of the present example had an excellent juicy texture even when frozen and then reheated, and textures such as fibrous texture, ease of loosening, and no roughness were also preferable, and the appearance at the time of eating was very preferable.

(Method for Producing Minced Meat Cutlet)

A hamburg steak was produced by the following procedure according to the blending shown in Table 8.

1. (Mixing of raw material A in inner layer) The raw material A described in the column of Inner layer in Table 8 was put into a bowl and kneaded by hand to make sticky.

2. (Mixing of raw material B in inner layer) The raw material B shown in Table 8 was added into another bowl and mixed.

3. (Kneading of inner layer) Mixtures of the raw materials A and B were put into a bowl of Kenmix mixer and mixed with a Kenmix mixer (strength 1) equipped with a whisk for 3 minutes to obtain a mixture for an inner layer.

4. (Mixing of raw material C in outer layer) Then, the raw material C described in Table 8 was put into a bowl and kneaded by hand to make sticky.

5. (Mixing of raw material D in outer layer) The raw material D shown in Table 8 was added into another bowl and mixed.

6. (Kneading of outer layer) Mixtures of the raw materials C and D were put into a bowl of Kenmix mixer and mixed with a Kenmix mixer (strength 1) equipped with a whisk for 3 minutes to obtain a mixture for an outer layer.

7. (Forming) 20 g of the mixture for an inner layer was rolled, rolled so as to cover it with 54 g of the mixture for an outer layer, and then formed into an oval shape by hand to obtain a food composition.

8. (Oven heating) A sponge dough was placed in an oven set at 250° C. and a relative humidity of 60% for 7 minutes to obtain preheated sponge dough.

9. (Cooling) The preheated mixture was allowed to cool at 25° C. until rough heat of the sponge dough was removed.

10. (Batter and bread crumbs) Preheated sponge dough was sprinkled with wheat flour batter (1.8 times watered) and then sprinkled with raw bread crumbs to obtain unfried minced meat cutlet.

11. (Freezing storage) The unfried minced meat cutlet obtained in 10. above was stored frozen at ° C. for 24 hours.

12. (Frying) Unfried minced meat cutlet as frozen was fried in rapeseed oil at 170° C. for 6 minutes to obtain a minced meat cutlet.

13. (Cooling) The minced meat cutlet was allowed to cool at 20° C. until rough heat thereof was removed.

14. (Range up) Using a microwave oven, it was heated at 700 W for 1 minute.

(Calculation of Cooking Yield)

A cooking yield was calculated by a formula below using the mass of the food composition after forming obtained in 7. above and the mass of the preheated sponge dough after steaming obtained in 9. above.

Cooking yield (%)=(Mass of sponge dough in preheating/Mass of food composition after forming)×100

The calculated values of each example are shown in Table 8. In Table 8, the component (A) in the “Component (A)/Food composition” is a total of the components (A) blended in the outer layer and the inner layer. In addition, the component (A) in the “Component (A)/Mixture for outer layer” and “Component (A)/Edible oil and fat composition added to mixture for inner layer” is the component (A) blended in the outer layer.

TABLE 8

| Raw material | | | | |
|---|---|---|---|---|
| (parts by mass) | | | Example 11 | Example 12 |
| Inner | A | Minced beef | 7.52 | 7.52 |
| layer | | Salt | 0.16 | 0.16 |
| | B | Sauteed onion | 5.00 | 5.00 |
| | | Chopped onion (raw) | 3.60 | 3.60 |
| | | Whole egg | 0.76 | 0.76 |
| | | Sugar | 0.24 | 0.24 |
| | | Slack pepper (coarsely-ground) | 0.04 | 0.04 |
| | | Liquid sugar | 0.40 | 0.40 |
| | | Water | 0.40 | 0.40 |
| | | Corn starch | 0.36 | 0.36 |
| | | Edible oil and fat composition 1 | 1.28 | 1.28 |
| | | Edible oil and fat composition 6 | 0.20 | 0.20 |
| | | Component (A): A1-1 | 0.04 | 0.04 |
| Total of mixture for inner layer | | | 20.00 | 20.00 |
| Edible oil and fat composition added to | | | 7.40 | 7.40 |
| mixture for inner layer (% by mass) | | | | |
| Outer | C | Minced beef | 15.39 | 15.39 |
| layer | | Minced pork | 5.94 | 5.94 |
| | | Salt | 0.32 | 0.32 |
| | D | Sauteed onion | 12.69 | 12.69 |
| | | Chopped onion (raw) | 4.86 | 4.86 |
| | | Raw bread crumbs | 4.05 | 3.51 |
| | | Whole egg | 4.32 | 4.32 |
| | | Granulated sugar | 0.32 | 0.32 |
| | | Liquid sugar | 0.54 | 0.54 |
| | | Sodium glutamate | 0.11 | 0.11 |
| | | White pepper | 0.05 | 0.05 |
| | | Soy protein | 0.81 | 0.81 |
| | | Water for soy protein | 3.78 | 3.78 |
| | | β starch | 0.54 | 0.54 |
| | | Component (A): A1-1 | 0.27 | 0.81 |

| | | |
|---|---|---|
| Total of mixture for outer layer | 54.00 | 54.00 |
| Component (A)/Mixture for outer layer (% by | 0.50 | 1.50 |
| mass) * | | |
| Component (A)/Food composition (% by mass) ** | 0.42 | 1.15 |
| Component (A)/Edible oil and fat composition | 0.18 | 0.55 |
| added to mixture for inner layer *** | | |
| Cooking yield (% by mass) | 94.6% | 97.9% |

Note)
* represents % by mass of component (A) with respect to entirety of mixture for outer layer.
** represents % by mass of component (A) with respect to entirety of food composition obtained by wrapping with Mixture for inner layer:Mixture for outer layer = 20:54 (Mass ratio)
*** represents mass ratio of component (A) to edible oil and fat composition added to mixture for inner layer, in food composition obtained by wrapping with Mixture for inner layer:Mixture for outer layer = 20:54 (Mass ratio)

The minced meat cutlets of Examples 11 and 12 were very juicy and preferable because the gravy overflowed from the inside when eaten.

Among these, when the content of the component (A) in the mixture for an outer layer was equal to or more than 0.50% by mass and equal to or less than 1.50% by mass, the juicy texture, the fibrous texture, and ease of loosening were excellent, and were more excellent in a case where the content was 1.50% by mass. Furthermore, the cooking yield before frying was more excellent in a case where the content of the component (A) was 1.50% by mass.

Further, even in a case where the component (A) was blended not only in the mixture for an outer layer but also in the mixture for an inner layer, a preferable minced meat cutlet was obtained.

Furthermore, even in a case where the food was frozen and stored in the middle of the cooking step, an effect of improving the juicy texture of the food wrapping filling and obtaining a food having an excellent appearance at the time of eating can be sufficiently exhibited.

(Hamburg Steak Production Examples 1 and 2)

Among the hamburg steak production methods, in the hamburg steak production example 1, the same blending as that of Example 2 is used to produce a hamburg steak by the same production method as that of Example 2, in the hamburg steak production example 2, except that 0.21 parts by mass of A-1 as the component (A) were blended in the raw material B of the mixture for an inner layer, and in both hamburg steak production examples 1 and 2, the following procedure was changed.

7. After (Forming), the obtained food composition was wrapped in a food film, placed in a plastic bag with a zipper, and stored frozen at −20° C. After 3 days, it was taken out of the freezer and thawed at 4° C. for 6 hours. The thawed food composition was subjected to 8. (Baking) and 9. (Steaming) to obtain a hamburg steak of the present example.

Priority is claimed on Japanese Patent Application No. 2018-226092, filed on Nov. 30, 2018, the entire disclosure of which is incorporated herein.

1. A method for producing a food comprising:
a step of mixing a component (A) below with a food material to obtain a mixture for an outer layer;
a step of mixing a food material to obtain a mixture for an inner layer; and
a step of wrapping the mixture for an inner layer with the mixture for an outer layer to obtain a food composition,
component (A): one or two selected from the group consisting of a component (A1) and a component (A2),
component (A1): a starch composition satisfying conditions of (1) to (3) below,
(1) a starch content is equal to or more than 75% by mass,
(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴, and
(3) a degree of swelling in cold water at 25° C. is equal to or more than 5 and equal to or less than 20, and
component (A2): pregelatinized starch.

2. The method according to claim 1,
wherein a blending amount of the component (A) is equal to or more than 0.08% by mass and equal to or less than 25% by mass in the mixture for an outer layer.

3. The method according to claim 1,
wherein a content of the mixture for an outer layer is equal to or more than 10% by mass and equal to or less than 90% by mass with respect to a total amount of the mixture for an outer layer and the mixture for an inner layer.

4. The method according to claim 1,
wherein a content of the component (A) contained in the mixture for an outer layer is equal to or more than 0.05% by mass and equal to or less than 20% by mass in the food composition.

5. The method according to claim 1,
wherein the food is a food cooked with heat.

6. The method according to claim 1,
wherein a content of the component (A1) under a sieve having a mesh size of 0.25 mm and on a sieve having a mesh size of 0.038 mm is equal to or more than 15% by mass and equal to or less than 100% by mass.

7. The method according to claim 1,
wherein a content of the component (A1) under a sieve having a mesh size of 3.35 mm and on a sieve having a mesh size of 0.038 mm is equal to or more than 60% by mass and equal to or less than 100% by mass.

8. The method according to claim 1,
wherein the food is one selected from a processed fish or livestock meat product food, a processed fish or livestock meat product-like food, and a bakery food wrapping filling.

9. The method according to claim 1,
wherein in the step in which the mixture for an inner layer is obtained, an edible oil and fat composition is added to the mixture for an inner layer such that a blending amount is equal to or more than 0.3% by mass and equal to or less than 40% by mass.

10. A food composition obtained by wrapping a mixture for an inner layer with a mixture for an outer layer,
wherein the mixture for an outer layer contains a component (A) below,
component (A): one or two selected from the group consisting of a component (A1) and a component (A2),
component (A1): a starch composition satisfying conditions of (1) to (3) below,
(1) a starch content is equal to or more than 75% by mass,
(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴, and
(3) a degree of swelling in cold water at 25° C. is equal to or more than 5 and equal to or less than 20, and
component (A2): pregelatinized starch.

11. The food composition according to claim 10,
wherein a content of the component (A) is equal to or more than 0.08% by mass and equal to or less than 25% by mass in the mixture for an outer layer.

12. The food composition according to claim 10,
wherein a content of the mixture for an outer layer is equal to or more than 10% by mass and equal to or less than 90% by mass with respect to a total amount of the mixture for an outer layer and the mixture for an inner layer.

13. The food composition according to claim 10,
wherein the mixture for an inner layer contains an edible oil and fat composition in an amount of equal to or more than 0.3% by mass and equal to or less than 40% by mass.

14. The food composition according to claim 10,
wherein a content of the component (A) under a sieve having a mesh size of 0.25 mm and on a sieve having a mesh size of 0.038 mm is equal to or more than 15% by mass and equal to or less than 100% by mass.

15. A food comprising the food composition according to claim 10.

16. The food according to claim 15,
wherein the food is one selected from a processed fish or livestock meat product food, a processed fish or livestock meat product-like food, and a bakery food wrapping filling.

17. A method for improving a juicy texture of a food containing a food composition obtained by wrapping a mixture for an inner layer with a mixture for an outer layer, the method comprising:
incorporating a component (A) below into the mixture for an outer layer,
component (A): one or two selected from the group consisting of a component (A1) and a component (A2),
component (A1): a starch composition satisfying conditions of (1) to (3) below,
(1) a starch content is equal to or more than 75% by mass,
(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴, and
(3) a degree of swelling in cold water at 25° C. is equal to or more than 5 and equal to or less than 20, and
component (A2): pregelatinized starch.

18. A method for improving an appearance, at the time of eating, of a food containing a food composition obtained by wrapping a mixture for an inner layer with a mixture for an outer layer, the method comprising:
incorporating a component (A) below into the mixture for an outer layer,
component (A): one or two selected from the group consisting of a component (A1) and a component (A2),
component (A1): a starch composition satisfying conditions of (1) to (3) below,
(1) a starch content is equal to or more than 75% by mass,
(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴, and
(3) a degree of swelling in cold water at 25° C. is equal to or more than 5 and equal to or less than 20, and
component (A2): pregelatinized starch.
